(19) United States
(12) Patent Application Publication
(10) Pub. No.: US 2026/0167112 A1
(43) Pub. Date: Jun. 18, 2026

(54) MOTOR VEHICLE WITH A CHARGING BASE, AND METHOD FOR BRINGING A CHARGING BASE INTO AN OPEN POSITION

(71) Applicant: AUDI AG, Ingolstadt (DE)

(72) Inventor: Rainer KOPP, Ingolstadt (DE)

(73) Assignee: AUDI AG, Ingolstadt (DE)

(21) Appl. No.: 19/125,826

(22) PCT Filed: Aug. 22, 2023
(86) PCT No.: PCT/EP2023/072965

§ 371 Date: Apr. 30, 2025

(30) Foreign Application Priority Data
Nov. 2, 2022 (DE) 102022128912.5

(51) Int. Cl. B60R 5/04; B60R 11/00; B60R 11/06

(52) U.S. Cl. CPC B60R 5/045; B60R 11/06; B60R 2011/0036; B60R 2011/0082; B60Y 2410/102

(57) ABSTRACT

A motor vehicle with a charging base which can be brought from a closed position into an open position. A holding device for holding the charging base in the open position includes a guide device. and by bringing the charging base into the open position, a bearing element of the charging base can be moved along the guide device into an end position in which the bearing element is arranged lower in the vertical direction of the motor vehicle than when the charging base is in the closed position. The bearing element can be moved from a starting position, which the bearing element assumes in the closed position of the charging base, into an intermediate position by rotating the bearing element about a pivot axis of the charging base, and the bearing element can be moved from the intermediate position into the end position.

### FIELD

The invention relates to a motor vehicle with a charging base which can be moved from a closed position, in which the charging base covers a space arranged in the vertical direction of the motor vehicle below the charging base, into an open position. In the open position the space is accessible. A holding device is provided for holding the charging base in the open position, wherein the holding device comprises at least one guide device. By moving the charging base into the open position, at least one bearing element of the charging base can be moved along the at least one guide device into an end position. In the end position, the at least one bearing element is arranged lower in the vertical direction of the motor vehicle than when the charging base is in the closed position. Furthermore, the invention relates to a method for moving a charging base of a motor vehicle from a closed position into an open position.

### BACKGROUND

It is impractical if a charging base of a motor vehicle, which has been moved into the open position in order to gain access to the space located below the charging base, does not remain in the open position but falls back shut due to gravity. This is because a user of the vehicle who wants to have access to the space or storage space and for this purpose moves the charging base into the open position must support the charging base himself.

CN 205905913 U describes a motor vehicle with a charging base which has strip-shaped fixing parts on each of the narrow sides in the region of a front end in the direction of travel of the motor vehicle. In trim parts which laterally delimit a charging space of the motor vehicle, a first, horizontally extending fixing groove and a second, inclined fixing groove are formed. When the strip-shaped fixing parts are inserted into the horizontal fixing grooves, the charging base is aligned horizontally. However, if the strip-shaped fixing parts are inserted into the inclined fixing grooves, the charging base is held in an open position by the fixing grooves.

A disadvantage here is the fact that handling the charging base when moving it from the closed position to the open position is comparatively laborious for a user of the motor vehicle.

Further options for securing a vehicle charging base in an open position are described in DE 10 2016 222 982 A1 and DE 10 2017 006 581 A1.

### SUMMARY

The object of the present invention is to provide a motor vehicle of the type mentioned at the outset in which the charging base can be moved from the closed position into the open position in a particularly user-friendly manner, and to provide a corresponding method.

The motor vehicle according to the invention has a charging base which can be moved from a closed position, in which the charging base covers a space arranged in the vertical direction of the motor vehicle below the charging base, into an open position. In the open position the space is accessible. A holding device on the motor vehicle serves to hold the charging base in the open position. The holding device comprises at least one guide device, wherein by bringing the charging base into the open position at least one bearing element of the charging base can be moved along the at least one guide device into an end position. In the end position, the at least one bearing element is arranged lower in the vertical direction of the motor vehicle than when the charging base is in the closed position. The at least one bearing element can be moved, by rotating about a pivot axis of the charging base, from a starting position, which the at least one bearing element assumes in the closed position of the charging base, into an intermediate position. From the intermediate position, the at least one bearing element can be moved into the end position.

In the motor vehicle, the charging base can therefore be moved from the closed position to the open position in a particularly user-friendly manner. This is because a user of the motor vehicle only needs to rotate the charging base around the pivot axis, or to pivot or fold it up. This allows the bearing element to move from the starting position to the intermediate position without any further action from the user. And as soon as the at least one bearing element is in the intermediate position, the at least one bearing element can be moved from the intermediate position to the end position.

Moving the charging base from the open position to the closed position, in which the holding device holds the charging base, is therefore particularly easy and intuitive for the user of the motor vehicle. The user is in fact used to rotating the charging base or folding it up around the pivot axis to move it from the closed to the open position. However, this movement, which is familiar to the user, is advantageously accompanied in the present case by the movement of the at least one bearing element from the starting position into the intermediate position, from which the at least one bearing element can reach the end position. By rotating or pivoting the charging base around the pivot axis, the bearing element can be moved slightly from the starting position to the intermediate position. And from the intermediate position, the bearing element can move unhindered to the end position, particularly supported by gravity.

In contrast, lowering of the bearing element in the vertical direction of the motor vehicle and thus direct movement of the bearing element into the end position is prevented when the bearing element assumes the starting position, i.e. when the charging base is in the closed position. This prevents the bearing element from undesirably sinking in the vertical direction of the motor vehicle when the charging base is in the closed position. This is advantageous in terms of user-friendliness when operating the charging base.

In the closed position, the charging base preferably assumes a desired position in which an end of the charging base remote from the pivot axis is preferably flush with components of the motor vehicle adjacent to the charging base. In this way, the charging base and the adjacent components form a continuous, preferably flat charging surface in a charging compartment of the motor vehicle.

Preferably, the at least one bearing element can be moved by rotating the charging base about the pivot axis from the starting position along the at least one guide device in the longitudinal direction of the motor vehicle into the intermediate position. In this case, the at least one bearing element is closer to a rear end of the motor vehicle in the starting position than in the intermediate position. This is particularly advantageous in order to achieve a continuous movement of the bearing element along the guide device when moving the bearing element from the starting position via the intermediate position to the end position.

Furthermore, by spacing the intermediate position relative to the starting position in the longitudinal direction of the motor vehicle away from the rear end of the motor vehicle, it can be ensured particularly easily that an undesired lowering of the bearing element in the vertical direction of the motor vehicle is avoided in the starting position. This lowering occurs in contrast when the bearing element is subsequently moved from the intermediate position to the final position.

Preferably, the holding device comprises at least one contact element spaced apart from the at least one guide device. An upper side of the charging base rests against the at least one contact element when the at least one bearing element is moved into the end position. By providing the contact element, the force required to hold the charging base in the open position does not need to be applied or provided by the guide device. Rather, the contact element of the holding device, which is spaced apart from the guide device, serves as an abutment for the upper side of the charging base when the charging base is in the open position.

This is advantageous because the guide device primarily serves to guide the bearing element when moving it from the starting position via the intermediate position to the end position and back. In contrast, the holding of the charging base in the open position is effected in particular by the at least one contact element.

By means of the at least one contact element, a large-area contact region can advantageously be provided in which the upper side of the charging base is in contact with the contact element when the charging base is in the open position and thus the bearing element is moved into the end position. In addition, the contact element, which is separate from and spaced apart from the guide device, can be easily designed to be sufficiently robust to ensure that the charging base is held securely in the open position.

Preferably, a free end region of the charging base is spaced from an end region of the at least one contact element near the charging base during the movement of the at least one bearing element from the starting position into the intermediate position. When the charging base is in the closed position, the free end region of the charging base is closer to the front end of the motor vehicle than to the rear end of the motor vehicle. By spacing the free end region of the charging base from the contact element during the pivoting movement, it is ensured that this pivoting movement of the charging base around the pivot axis can take place unhindered. This is advantageous for trouble-free handling when moving the charging base from the closed position to the open position and back.

Preferably, the at least one guide device has at least one latching threshold which has to be overcome when moving the at least one bearing element from the starting position into the intermediate position. By providing at least one latching threshold, an unintentional movement of the bearing element from the starting position to the intermediate position is advantageously avoided.

In addition, by providing at least one latching threshold, haptic and/or acoustic feedback can be provided to the user of the motor vehicle when the user moves the charging base from the open position back into the closed position. In this case, too, the latching threshold must first be overcome in order to move the bearing element into the starting position from the intermediate position.

Preferably, the bearing element has a non-slip coating at least in a contact region in which the at least one bearing element is in contact with boundary walls of the at least one guide device during movement from the starting position to the intermediate position. The non-slip coating is designed to assist in overcoming the at least one latching threshold. Accordingly, the non-slip coating of the bearing element advantageously ensures that the at least one latching threshold can be particularly easily overcome, in particular rolled over, when the bearing element is moved from the starting position to the intermediate position when the charging base is rotated about the pivot axis.

The non-slip coating, which is formed in particular from a rubber material or similar flexible material, also advantageously ensures an elastic and thus particularly quiet or noiseless mounting of the bearing element in the guide device when the bearing element is in the starting position.

The non-slip coating or friction coating can be designed in the manner of a shell which surrounds or encloses a, in particular cylindrical, base body of the bearing element. By means of such a design of the bearing element, it is possible in a particularly simple manner to roll over the latching threshold when the bearing element is moved from the starting position to the intermediate position.

Preferably, the at least one bearing element is received in the starting position in a latching recess of the at least one guide device. This ensures a well-defined support of the bearing element in the guide device when the bearing element is in the starting position.

Preferably, the at least one bearing element is designed as a bearing pin through which the pivot axis of the charging base is provided. In this way, the bearing element is designed to be particularly robust and resilient. In addition, a very precise guidance of the bearing element along the guide device can be achieved when the bearing element is moved from the starting position via the intermediate position to the end position. This preferably also applies when the bearing element is moved from the end position via the intermediate position back to the starting position when the charging base is moved from the open position to the closed position.

Preferably, an end portion of the at least one guide device, along which the at least one bearing element can be moved from the intermediate position to the end position, forms an acute angle with the vertical direction of the motor vehicle. By aligning the end portion of the guide device in such a way that it is inclined to the vertical direction of the motor vehicle, it can be achieved that the entire charging base forms an acute angle with the vertical direction of the motor vehicle when the charging base is in the open position.

This means that, on the one hand, the space located below the charging base when the charging base is closed is particularly easy to access when the charging base is in the open position. Furthermore, this prevents the charging base in the open position from taking up space which is or can be provided for other components of the motor vehicle, for example in the form of seats in a rear row of seats of the motor vehicle, which are arranged in front of the charging base in the longitudinal direction or direction of travel of the motor vehicle. This is advantageous.

The motor vehicle may have a second row of seats arranged in the longitudinal direction of the motor vehicle behind a driver's seat and a passenger seat and a third row of seats arranged behind the second row of seats. The charging base is located behind the third row of seats. In particular, in the case of such a charging base which is arranged behind the third row of seats of the motor vehicle, it is particularly advantageous if the charging base is held in the open position by means of the holding device. This is because in particular the third row of seats in the vehicle can prevent the charging base from being raised to the vertical or even beyond. Therefore, the movement mechanism described above for moving the charging base is particularly advantageous in the motor vehicle having the third row of seats.

In the method according to the invention for moving a charging base of a motor vehicle from a closed position, in which the charging base covers a space arranged in the vertical direction of the motor vehicle below the charging base, into an open position in which the space is accessible, a holding device of the motor vehicle holds the charging base in the open position. The holding device comprises at least one guide device, wherein by bringing the charging base into the open position at least one bearing element of the charging base can be moved along the at least one guide device into an end position. In the end position, the at least one bearing element is arranged lower in the vertical direction of the motor vehicle than when the charging base is in the closed position. The at least one bearing element is moved, by rotating about a pivot axis of the charging base, from a starting position, which the at least one bearing element assumes in the closed position of the charging base, into an intermediate position. From the intermediate position, the at least one bearing element is moved into the end position.

Such a method for moving the charging base into the open position is particularly user-friendly. This is because rotating the charging base around the pivot axis causes the bearing element to move from the starting position to the intermediate position. And from the intermediate position, the bearing element moves very easily, preferably supported by gravity, into the end position. Consequently, moving the charging base from the closed position to the open position is very easy, effortless and intuitive for the user of the motor vehicle.

The advantages and preferred embodiments described for the motor vehicle according to the invention also apply to the method according to the invention and vice versa.

The invention accordingly also includes developments of the method according to the invention, which have features as already described in the context of the developments of the motor vehicle according to the invention. For this reason, the corresponding developments of the method according to the invention are not described again here.

The motor vehicle according to the invention is preferably designed as an automobile, in particular as a passenger car or truck, or as a passenger bus.

The invention also comprises the combinations of the features of the described embodiments. The invention therefore also comprises implementations which each have a combination of the features of several of the described embodiments, unless the embodiments have been described as mutually exclusive.

### BRIEF DESCRIPTION OF THE FIGURES

Exemplary embodiments of the invention are described hereinafter. In the figures:

FIG. 1 shows, in a schematic rear view, a rear region of a motor vehicle, wherein a charging base arranged in the rear region of the motor vehicle is shown on the one hand in a closed position and on the other hand in an open position;

FIG. 2 schematically shows the charging base according to FIG. 1 in a side sectional view;

FIG. 3 shows a detail of a front end region of the charging base in the direction of travel in the closed position and in the open position, showing the shape of a guide device along which a bearing element of the charging base designed as a bearing pin moves when the charging base is moved from the closed position into the open position;

FIG. 4 shows, in a side view, a charging base support comprising a holding device which serves to hold the charging base in the open position, wherein the holding device also shows the guide device shown in FIG. 3 and a contact element; and

FIG. 5 shows, in a highly schematic plan view, the motor vehicle with a third row of seats, behind which the charging base can be arranged.

### DETAILED DESCRIPTION

The exemplary embodiments explained below are preferred embodiments of the invention. In the exemplary embodiments, the described components of the embodiments each represent individual features of the invention to be considered independently of one another, which each also develop the invention independently of one another. Therefore, the disclosure is also predetermined to comprise combinations of the features of the embodiments other than those represented. Furthermore, the described embodiments can also be supplemented by further ones of the above-described features of the invention.

In the figures, same reference numerals respectively designate elements that have the same function.

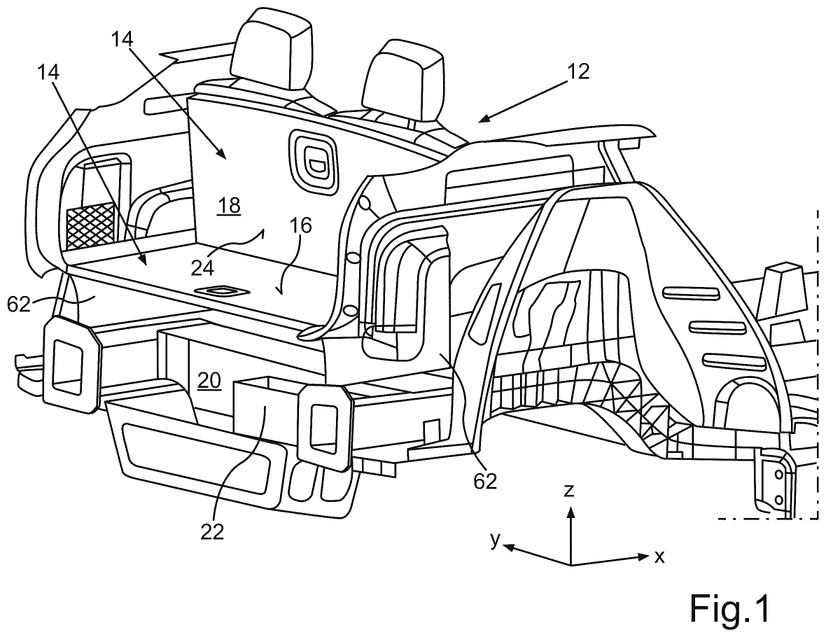

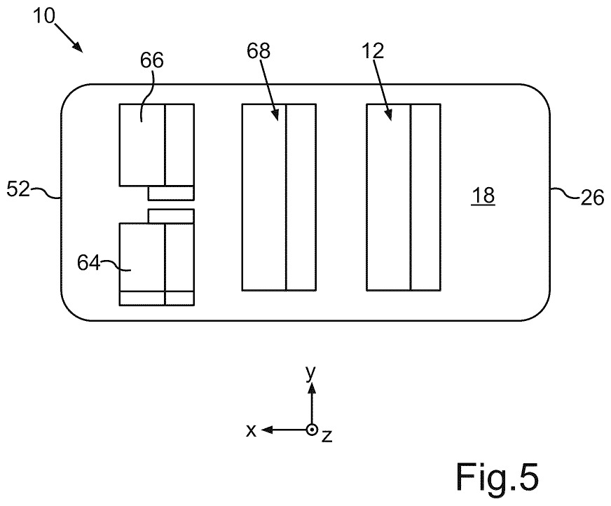

In FIG. 1, a rear region of a motor vehicle 10 (see FIG. 5) is shown, which is located behind a third row of seats 12 of the motor vehicle 10 (see FIG. 5). In the rear region of the motor vehicle 10, a charging base 14 is arranged, which is shown in FIG. 1 in a closed position and in an open position. In the closed position of the charging base 14, a charging space 18 of the motor vehicle 10 is delimited on the underside by an upper side 16 of the charging base 14. Furthermore, in the closed position of the charging base 14, a space 20 or storage space arranged in the vertical direction z of the motor vehicle 10 below the charging base 14 is concealed. In this space 20 or storage space, utensils such as a toolbox 22 or the like can be stored.

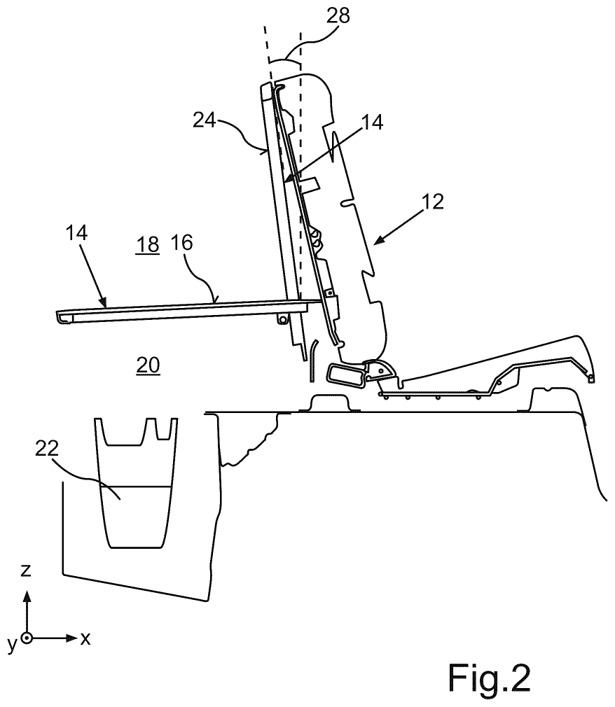

Furthermore, in FIG. 1 and FIG. 2 the charging base 14 is shown in an open position. In the open position of the charging base 14, an underside 24 of the charging base 14 faces a rear end 26 of the motor vehicle 10 (see FIG. 5).

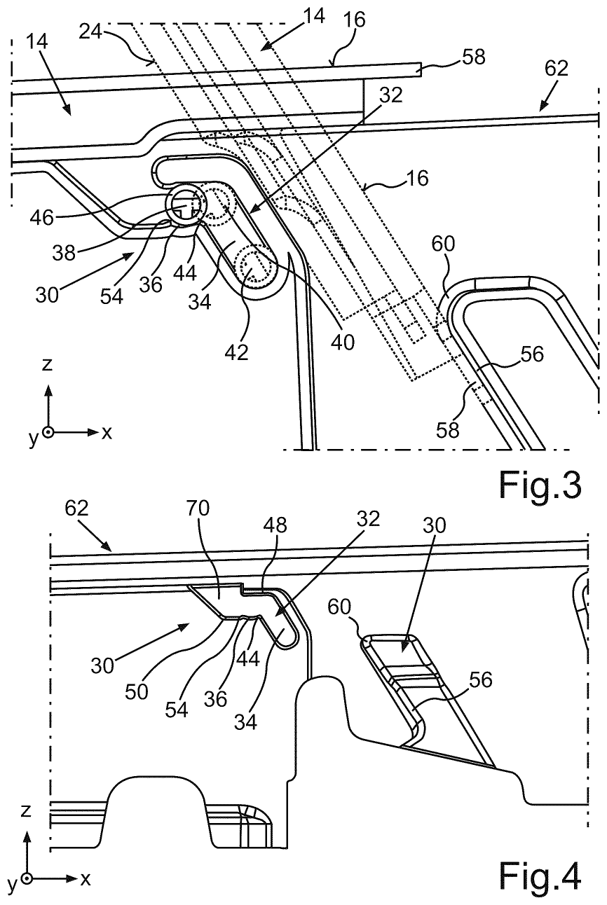

In particular, it can be seen from FIG. 2 that the charging base 14, when moved into the open position, forms an angle 28 with the vertical direction z of the motor vehicle 10 or with the vehicle vertical axis, which angle is designed as an acute angle 28. The angle 28 can in particular be approximately 5°. Accordingly, the charging base 14 is not completely vertical in the open position. Nevertheless, in this case it is prevented that the charging base 14 moves unintentionally from the open position to the closed position due to gravity. This is ensured by a holding device 30, the components and functioning of which will be explained in more detail with reference to FIG. 3.

On the one hand, the holding device 30 comprises a guide device 32, which in the present case is designed as a guide slot, with an end portion 34. The end portion 34 in the present case encloses the same acute angle 28 (see FIG. 2) with the vertical direction z of the motor vehicle 10 as the charging base 14 itself when the charging base 14 is in the open position.

Furthermore, the guide device 32 comprises a latching recess 36. A bearing element 38 of the charging base 14, which is designed as a bearing pin in the present case, is received in this latching recess 36 when the bearing element 38 is in a starting position.

Preferably, respective bearing elements 38 are arranged on the two sides of the charging base 14 opposite one another in the vehicle transverse direction y, which bearing elements are guided in respective guide devices 32 designed as slots or guide slots. In the present case, the pivot axis of the charging base 14 is provided by the at least one bearing element 38. For the sake of simplicity, only one of these bearing elements 38, namely the bearing element 38 shown in FIG. 3 and its movement when moving the charging base 14 into the open position, will be discussed in more detail below.

When the charging base 14 is moved from the closed position to the open position by rotating about the pivot axis, the bearing element 38 initially moves from the starting position, which the bearing element 38 assumes when the bearing element 38 is located in the latching recess 36, into an intermediate position 40.

In FIG. 3, this intermediate position 40 is illustrated by the bearing element 38 shown a second time, which is moved from the starting position, in which the bearing element 38 is arranged in the latching recess 36, in the longitudinal direction x of the motor vehicle 10 into the intermediate position 40. In the intermediate position 40, the bearing element 38 is further away from the rear end 26 (see FIG. 5) of the motor vehicle 10 than in the starting position. In other words, the bearing element 38 is closer to the rear end 26 of the motor vehicle 10 in the starting position than in the intermediate position 40.

When the bearing element 38 is in the intermediate position 40, the bearing element 38 can be moved along the end portion 34 of the guide device 32 into an end position 42. For reasons of clarity, the end position 42 is also illustrated in FIG. 3 by the bearing element 38 shown a third time, which has reached the lower end of the end portion 34 of the guide device 32 in the vertical direction z.

The movement of the bearing element 38 from the intermediate position 40 to the end position 42 is supported by gravity.

Accordingly, the bearing element 38 slides unhindered from the intermediate position 40 along the end portion 34 into the end position 42.

In order to move the bearing element 38 from the starting position and thus from the latching recess 36 into the intermediate position 40, the user of the motor vehicle 10 only needs to rotate or pivot the charging base 14 about the pivot axis. In this case, the bearing element 38 rolls over a latching threshold 44, which limits the latching recess 36 to the end portion 34 of the guide device 32.

In order to support or facilitate overcoming the latching threshold 44, the bearing element 38, which is designed as a bearing pin in the present case, has a non-slip coating 46. The non-slip coating 46 is in contact with boundary walls 48, 50 of the guide device 32 (see FIG. 4), while the bearing element 38 is moved from the starting position to the intermediate position 40.

In particular, it can be seen from FIG. 3 that in the present case the latching recess 36 is delimited by a further latching threshold 54 on one side which faces the rear end 26 of the motor vehicle 10 (see FIG. 5). Thus, in the starting position, a well-defined position of at least one bearing element 38 of the charging base 14 is predetermined.

In FIG. 3, the charging base 14 is additionally shown in detail in the open position, in which the underside 24 of the charging base 14 faces the rear end 26 of the motor vehicle 10 (see FIG. 5). Accordingly, the upper side 16 of the charging base 14 is no longer essentially horizontally aligned, but inclined. In the open position of the charging base 14, when the bearing element 38 is moved into the end position 42, the upper side 16 of the charging base 14 rests against a contact element 56 of the holding device 30, which is spaced from the guide device 32 (see FIG. 3).

In the present case, it is ensured that a free end region 58 of the charging base 14 is spaced from an end region 60 of the contact element 56 close to the charging base 14 during the movement of the bearing element 38 from the starting position into the intermediate position 40. Accordingly, the free end region 58 of the charging base 14 does not collide with this end region 60 of the contact element 56 while the bearing element 38 is moved from the starting position to the intermediate position 40.

Due to the subsequent displacement of the bearing element 38 from the intermediate position 40 into the end position 42, the upper side 16 of the free end region 58 of the charging base 14 comes into contact with the contact element 56 of the holding device 30, as shown in FIG. 3 for the charging base 14 moved into the open position.

In the closed position of the charging base 14, the free end region 58 of the charging base 14 is closer to a front end 52 of the motor vehicle 10 (see FIG. 5) than to the rear end 26 of the motor vehicle 10.

In the present case, it is preferably ensured that during the movement of the charging base 14 from the closed position to the open position, no interfering contours in the charging space 18 of the motor vehicle 10 (see FIG. 1 and FIG. 5) hinder or impair this movement of the charging base 14.

From FIG. 4 it can be seen that the holding device 30 is integrated in a charging base support 62, which serves to support the charging base 14 both in its closed position and in its open position. In the present case, two such charging base supports 62 are arranged at a distance from one another in the vehicle transverse direction y on the sides of the charging space 18 that are opposite one another in the vehicle transverse direction y.

From FIG. 4 it can also be seen that the guide device 32, which is designed in the manner of a slotted link or guide slotted link, is open at an end 70 opposite the end portion 34. This makes it possible to remove the charging base 14 from the motor vehicle 10. When the charging base 14 is removed from the motor vehicle 10, the bearing elements 38 or bearing pins pass this end 70 of the respective guide device 32.

According to FIG. 5, the motor vehicle 10 in the present case has a driver's seat 64 and a passenger seat 66, which are shown only in a highly schematic manner in FIG. 5. In the longitudinal direction x of the motor vehicle 10, behind the driver's seat 64 and the passenger seat 66, a second row of seats 68 of the motor vehicle 10 is arranged. In the longitudinal direction x behind this second row of seats 68, the third row of seats 12 is arranged, which is also shown in FIG. 1. In particular in such a motor vehicle 10, which has, for example, seven seats usable by vehicle occupants of the motor vehicle 10, the holding of the charging base 14 in the open position described here is advantageous.

Overall, the examples show how a removable charging base 14 can be provided for a charging space 18 or trunk of a motor vehicle 10, which can be set up and which can be locked or fixed in the set up position or open position.

1-10. (canceled)

11. A motor vehicle with a charging base which can be moved from a closed position, in which the charging base covers a space arranged below the charging base in the vertical direction of the motor vehicle, into an open position, in which the space is accessible, and with a holding device for holding the charging base in the open position, wherein the holding device comprises at least one guide device, and wherein, by moving the charging base into the open position, at least one bearing element of the charging base can be moved along the at least one guide device into an end position, in which the at least one bearing element is arranged lower in the vertical direction of the motor vehicle than when the charging base is in the closed position,
wherein the at least one bearing element can be moved, by rotating about a pivot axis of the charging base, from a starting position, which the at least one bearing element assumes in the closed position of the charging base, into an intermediate position, from which the at least one bearing element can be moved into the end position.

12. The motor vehicle according to claim 11, wherein the at least one bearing element can be moved by rotating the charging base about the pivot axis from the starting position along the at least one guide device in the longitudinal direction of the motor vehicle into the intermediate position, wherein the at least one bearing element is closer to a rear end of the motor vehicle in the starting position than in the intermediate position.

13. The motor vehicle according to claim 11, wherein the holding device comprises at least one contact element spaced from the at least one guide device, against which an upper side of the charging base rests when the at least one bearing element is moved into the end position.

14. The motor vehicle according to claim 13, wherein a free end region of the charging base, which in the closed position of the charging base is closer to a front end of the motor vehicle than to a rear end of the motor vehicle, is spaced from an end region of the at least one contact element close to the charging base during the movement of the at least one bearing element from the starting position into the intermediate position.

15. The motor vehicle according to claim 11, wherein the at least one guide device has at least one latching threshold which has to be overcome when moving the at least one bearing element from the starting position into the intermediate position.

16. The motor vehicle according to claim 15, wherein the at least one bearing element has, at least in a contact region in which the at least one bearing element is in contact with boundary walls of the at least one guide device during movement from the starting position into the intermediate position, a non-slip coating which is designed to assist in overcoming the at least one latching threshold.

17. The motor vehicle according to claim 11, wherein the at least one bearing element is received in the starting position in a latching recess of the at least one guide device and/or the at least one bearing element is designed as a bearing pin, by means of which the pivot axis of the charging base is provided.

18. The motor vehicle according to claim 11, wherein an end portion of the at least one guide device, along which the at least one bearing element can be moved from the intermediate position into the end position, encloses an acute angle with the vertical direction of the motor vehicle.

19. The motor vehicle according to claim 11, wherein the motor vehicle has a second row of seats arranged in the longitudinal direction of the motor vehicle behind a driver's seat and a passenger seat and a third row of seats arranged behind the second row of seats, wherein the charging base is arranged behind the third row of seats.

20. A method for moving a charging base of a motor vehicle from a closed position, in which the charging base covers a space arranged below the charging base in the vertical direction of the motor vehicle, into an open position, in which the space is accessible, and wherein a holding device of the motor vehicle holds the charging base in the open position, wherein the holding device comprises at least one guide device, and wherein, by moving the charging base into the open position, at least one bearing element of the charging base is moved along the at least one guide device into an end position, in which the at least one bearing element is arranged lower in the vertical direction of the motor vehicle than when the charging base is in the closed position,
wherein the at least one bearing element is moved, by rotating about a pivot axis of the charging base, from a starting position, which the at least one bearing element assumes in the closed position of the charging base, into an intermediate position, from which the at least one bearing element is moved into the end position.

21. The motor vehicle according to claim 12, wherein the holding device comprises at least one contact element spaced from the at least one guide device, against which an upper side of the charging base rests when the at least one bearing element is moved into the end position.

22. The motor vehicle according to claim 12, wherein the at least one guide device has at least one latching threshold which has to be overcome when moving the at least one bearing element from the starting position into the intermediate position.

23. The motor vehicle according to claim 13, wherein the at least one guide device has at least one latching threshold which has to be overcome when moving the at least one bearing element from the starting position into the intermediate position.

24. The motor vehicle according to claim 14, wherein the at least one guide device has at least one latching threshold which has to be overcome when moving the at least one bearing element from the starting position into the intermediate position.

25. The motor vehicle according to claim 12, wherein the at least one bearing element is received in the starting position in a latching recess of the at least one guide device and/or the at least one bearing element is designed as a bearing pin, by means of which the pivot axis of the charging base is provided.

26. The motor vehicle according to claim 13, wherein the at least one bearing element is received in the starting position in a latching recess of the at least one guide device and/or the at least one bearing element is designed as a bearing pin, by means of which the pivot axis of the charging base is provided.

27. The motor vehicle according to claim 14, wherein the at least one bearing element is received in the starting position in a latching recess of the at least one guide device and/or the at least one bearing element is designed as a bearing pin, by means of which the pivot axis of the charging base is provided.

28. The motor vehicle according to claim 15, wherein the at least one bearing element is received in the starting position in a latching recess of the at least one guide device and/or the at least one bearing element is designed as a bearing pin, by means of which the pivot axis of the charging base is provided.

29. The motor vehicle according to claim 16, wherein the at least one bearing element is received in the starting position in a latching recess of the at least one guide device and/or the at least one bearing element is designed as a bearing pin, by means of which the pivot axis of the charging base is provided.

30. The motor vehicle according to claim 12, wherein an end portion of the at least one guide device, along which the at least one bearing element can be moved from the intermediate position into the end position, encloses an acute angle with the vertical direction of the motor vehicle.
